(19) United States
(12) Patent Application Publication
(10) Pub. No.: US 2005/0092683 A1
(43) Pub. Date: May 5, 2005

(54) Membrane devices for pervaporation, gas separations, and perstraction with permeate and sweep fluid conduit and method of use

(76) Inventor: Robert L. Goldsmith, Wayland, MA (US)

Correspondence Address: NIELDS & LEMACK, 176 EAST MAIN STREET, SUITE 7, WESTBORO, MA, 01581, US

(21) Appl. No.: 10/698,267

(22) Filed: Oct. 31, 2003

(51) Int. Cl. B01D 61/00

(52) U.S. Cl. 210/640; 95/45; 210/506; 210/510.1; 96/11

(57) ABSTRACT

A membrane device that receives a feedstock at a feed end face and separates the feedstock into a gas-phase permeate and retentate. The device has a membrane support containing at least one monolith of porous material defining a plurality of passageways extending longitudinally from the feed end face of the monolith to a retentate end face of the monolith through which the feedstock flows to pass retentate from the device. A permselective membrane coating is applied to the passageway wall surfaces of the monolith. At least one permeate conduit is formed within the monolith, the conduit containing a plurality of longitudinal permeate chambers communicating with a means of a sweep fluid introduction into the chambers and sweep fluid and permeate withdrawal from the chambers. The permeate is separated from feed and retentate, and the permeate is removed in a sweep fluid circulated through the permeate conduit.

### FIELD OF THE INVENTION

This invention relates to an improved membrane device that receives a feedstock at a feed end face and separates the feedstock into a gas-phase permeate and retentate. The device has a membrane support containing at least one monolith of porous material defining a plurality of passageways extending longitudinally from the feed end face of the monolith to a retentate end face of the monolith. At least one permeate conduit is formed within the monolith, the conduit containing a plurality of longitudinal permeate chambers communicating with a means of sweep fluid introduction and a separate means of sweep fluid and permeate withdrawal. The flows of sweep fluid and permeate are separated from feed and retentate flows.

### BACKGROUND OF THE INVENTION

For membrane devices used for pervaporation and gas separations, the permeate product is removed in the gas phase. It is important to maintain an effective partial pressure driving force for the permeating species between the feedstock and the location of permeate withdrawal. In general, the partial pressure of permeating species is kept low to maintain a high partial pressure driving force. This is often implemented by withdrawing the gas-phase permeate with a vacuum pump or contained in a sweep fluid. For low flow systems, a vacuum pump is often a preferred solution, while for larger flow systems, a condensable sweep fluid can be preferred since the power cost for recompression of a gas-phase permeate using a vacuum pump can be unacceptably high. A general description of these alternatives, for the important application of hydrogen purification, is contained in the review paper of Paglieri and Way (“Innovations in Palladium Membrane Research’, in Separation and Purification Methods, 31(1), pages 56-58 (2002)).

The use of a sweep fluid in membrane devices suitable for pervaporation, gas separations, and perstraction, in which permeate is removed as a gas or vapor, has been applied to many different membrane module configurations. One module configuration for which this has not been done, and a configuration well suited for elevated temperature gas separations, is the monolith membrane module structures developed by Goldsmith, et al., disclosed in U.S. Pat. No. 4,781,831, U.S. Pat. No. 5,009,781, U.S. Pat. No. 5,108,601, and U.S. Pat. No. 6,126,833, incorporated herein by reference. In these patents, large-diameter, multi-channel membrane elements are described. The distinguishing characteristic of these elements is that they contain one or more internal permeate conduits for extracting permeate from the interior of the elements, circumventing a permeate-side pressure drop within multi-channel monolith membrane devices that would otherwise limit performance of such devices. These devices were developed primarily for applications in which a liquid permeate is withdrawn, and for which permeate pressure drop from within the permeate conduit to an external permeate collection zone was unimportant. However, for the applications of pervaporation and gas separations, the pressure drop for permeate from within the permeate conduit structure to an external permeate collection zone can be significant, especially when the permeate is withdrawn at low pressure or under vacuum.

A preferred embodiment of the Goldsmith devices includes permeate extraction channels formed at one or both ends of a large diameter monolith, preferably in the form of slots, intersecting permeate chambers extending longitudinally along the length of the membrane element. The presence of these channels, when present at both ends of the membrane element, affords a novel means of circulating a sweep fluid through the permeate conduit, counter-currently or co-currently with feed flow, to achieve a reduced partial pressure of a permeating gas species within the conduit, and minimizing the partial pressure difference of the gas species between the conduit and an external permeate collection zone.

Another embodiment of the Goldsmith devices includes a means of permeate extraction from a monolith membrane element using permeate ducts situated at the end faces of the membrane element, the ducts communicating with the internal permeate conduit chambers through internal transverse channels. The presence of these ducts, when present at both ends of the membrane element, affords a second novel means of circulating a sweep fluid through the permeate conduit.

These constructions are amenable to the circulation of a sweep fluid to maintain a reduced partial pressure for a permeating gas-phase species within a permeate conduit and form the basis for the present invention.

### SUMMARY OF THE INVENTION

This invention relates to an improved multi-channel monolith membrane device for separating a feedstock into a gas-phase permeate and retentate, more particularly to such a device having at least one permeate conduit within the device that provides enhanced permeate removal from within the device to a permeate collection zone external to the device and which permeate conduit is used to circulate a sweep fluid within the device to remove the gas-phase permeate and maintain a reduced permeating species partial pressure within the permeate conduit.

It is therefore an object of this invention to provide an improved multichannel monolith membrane device in which a permeate product is removed in the gas phase within at least one internal permeate conduit, the device employing a sweep fluid circulated through the permeate conduit to maintain a reduced partial pressure of the permeating species.

It is a further object of this invention to provide such a device that has a large amount of membrane area per unit volume of the device.

It is a further object of this invention to provide such a device which uses a large-diameter, multiple-passageway monolith as a membrane support, the device utilizing a small fraction of the monolith passageways for the permeate conduit structure.

This invention results from the realization that membrane modules that remove permeate in the gas phase perform optimally when the partial pressure of permeating species downstream of the membrane is minimized.

This invention also results from the realization that large diameter monolith based membrane devices can be constructed with one or more internal permeate conduits to beneficially extract permeate from within the device, and that if the permeate is removed in the gas phase that the permeate pressure drop from within the permeate conduit to an external permeate collection zone can be unacceptably high.

Finally, this invention results from the realization that such permeate conduit structures can be used for circulation of a sweep fluid through the permeate conduit structure to reduce the difference in the partial pressure of permeating species between the permeate conduit and the external permeate collection zone.

This invention features a membrane device for receiving a feedstock at a feed end face and for separating the feedstock into a gas-phase permeate and retentate. The device uses a membrane support containing at least one monolith of porous material defining a plurality of passageways, with passageway wall surfaces, extending longitudinally from the feed end face of the monolith to a retentate end face of the monolith through which the feedstock flows to pass retentate from the device. A permselective membrane coating is applied to the passageway wall surfaces. At least one permeate conduit is formed within the monolith, the conduit containing a plurality of longitudinal permeate chambers transected by permeate channels, the channels providing a means for introduction of a sweep fluid into the permeate chambers and withdrawal of the sweep fluid and gas-phase permeate from the permeate chambers. Further, a means of separating the sweep fluid and gas-phase permeate flows from the feed and retentate flows is provided.

The membrane support can be a single monolith, or alternatively a plurality of monolith segments.

In one embodiment, the permeate channels are located at or near the end faces of the monolith. The permeate channels can be slots at the end faces of the monolith which are sealed to isolate the permeate chambers from feed and retentate. The channels can communicate with an annular space between the membrane device and a permeate collection housing.

In another embodiment, the means of sweep fluid introduction and withdrawal are ducts at the feed end face and the retentate end face, respectively.

This invention also features a method of separating a feedstock in a membrane device into a gas-phase permeate and retentate. The method uses any of the above devices contained within a permeate collection housing and has a means for separating gas-phase permeate from feedstock and retentate flows. A feedstock is introduced into the feed end face of the device and into a plurality of the device passageways for separation into a gas-phase permeate and retentate, and the retentate is removed from the retentate end face of the device. A sweep fluid is introduced into the permeate conduit of the device and the sweep fluid and gas-phase permeate are removed from the permeate conduit of the device.

### DESCRIPTION OF THE DRAWINGS

FIG. 1 shows a monolith membrane element 1 with one or more internal permeate conduits (three shown) contained in a housing 2. This construction is suitable for a membrane module (membrane element in permeate collection housing) for which permeate collection would normally be along the side of the membrane element. The permeate conduit structure includes slots 3 and 4 at the inlet and outlet ends of the element. The slots intersect and communicate with internal longitudinal permeate conduit chambers 5, which extend along the length of the element. These slots and chambers provide a means of implementing sweep fluid flow circulation internal to the element.

FIG. 2 shows an alternative monolith membrane element 1 with one or more internal permeate conduits (three shown) contained in a housing 2. In this instance, the permeate flow is through ducts 6 and 7 located at an inlet end face 8 and an outlet end face 9 of the membrane element. These ducts communicate with the internal longitudinal permeate conduit chambers and provide an alternative means of sweep fluid circulation through the internal permeate conduit system.

### DETAILED DESCRIPTION OF THE EMBODIMENTS

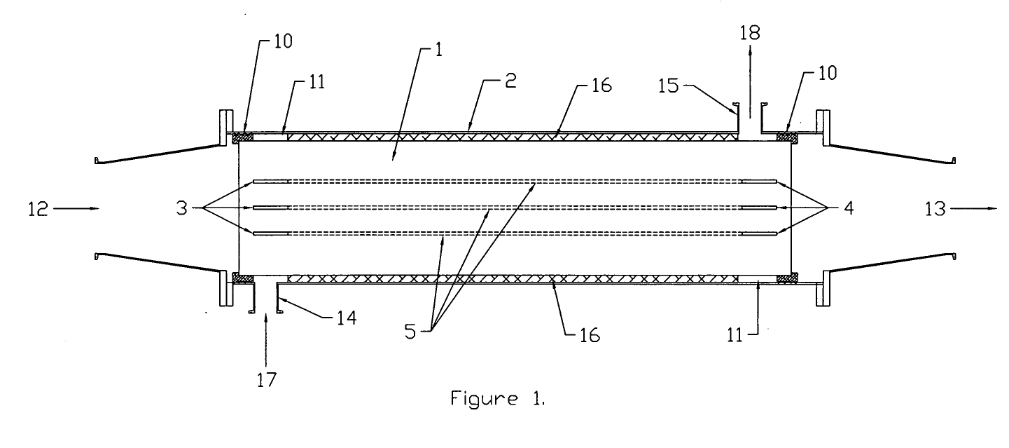

In FIG. 1, a monolith membrane element 1 is contained with a module housing 2, with means 10 for isolating a permeate collection zone 11 from a feedstock inlet 12 and a retentate outlet 13. The membrane element contains one or more transverse slots 3 and 4 at the feed inlet and retentate outlet ends of the element, respectively, or other channels. The slots transect a plurality of longitudinal permeate conduit chambers 5, and this constitutes one form of a permeate conduit, as described in the above-referenced Goldsmith patents. Permeate ports 14 and 15 are located on the module housing near the inlet and outlet ends, respectively. A flow resistance material 16 can be used to fill the permeate collection zone annulus situated between the membrane element and the module housing to increase a sweep fluid flow resistance in this annular space.

In operation, a liquid or gas mixture feed under pressure is circulated through the membrane module from the feed end to the retentate end. Simultaneously, a sweep fluid can be circulated through the permeate conduit structure, as well as through the filler material in the annular space. Preferably, the sweep fluid flow is counter-current with feed gas flow so as to maintain the lowest permeating species partial pressure at the retentate end of the module, where the feed partial pressure of the permeating species is the lowest. This is important when the reduction in permeating species concentration in the feed channels is substantial from the feed end to the retentate end.

When permeate is also withdrawn through exterior surface of the membrane element, the resistance for sweep fluid flow through the annulus, with or without the flow resistance material, is preferably comparable to the flow resistance for sweep fluid flow through the permeate conduit structure. If permeate is not removed through the exterior surface of the element, the sweep fluid flow through the annular space is preferably small or negligible.

A preferred structure of the permeate conduits for a unitary monolith membrane element contains a plurality of permeate chambers within the monolith which extend along the length of the monolith. The chambers preferably are in the form of one or more rows of monolith passageways. At both ends of the monolith, the permeate conduit chambers are transected by one or more transverse channels that communicate between the chambers and a permeate collection zone disposed along at least one side of the membrane element. The channels are preferably in the form of slots, sealed at the ends of the monolith element to prevent entry of feed or retentate material. A mechanical means is employed at the periphery of the monolith element ends to prevent mixing of feed or retentate with the permeate collected in the permeate collection zone.

For the multi-segment membrane module structures disclosed in U.S. Pat. No. 6,126,833, the permeate conduit structure consists of the above-described intra-segment structure within at least one monolith segment as well as an inter-segment permeate conduit structure defined by the space among the monolith segments.

The flow resistance material in the permeate annulus can take different forms. For example, the material can be a constrained bed of granular material, of a size such that the flow resistance through the bed of the granular material is relatively high. The granular material can be a powder comprised of a ceramic, glass, metallic, polymeric or other material. An alternative is to use a mesh wrapped or slipped around the monolith peripheral surface, plastic or metal, to fill the permeate cavity. The flow resistance material could also be comprised of open-cell or closed-cell foam, or a rubber mat, or any other material or means useful for creating a flow resistance within, or blockage of, the annular space. Considerations important for selection of the flow resistance material, other than its flow resistance properties, include ease of installation, and chemical and thermal durability.

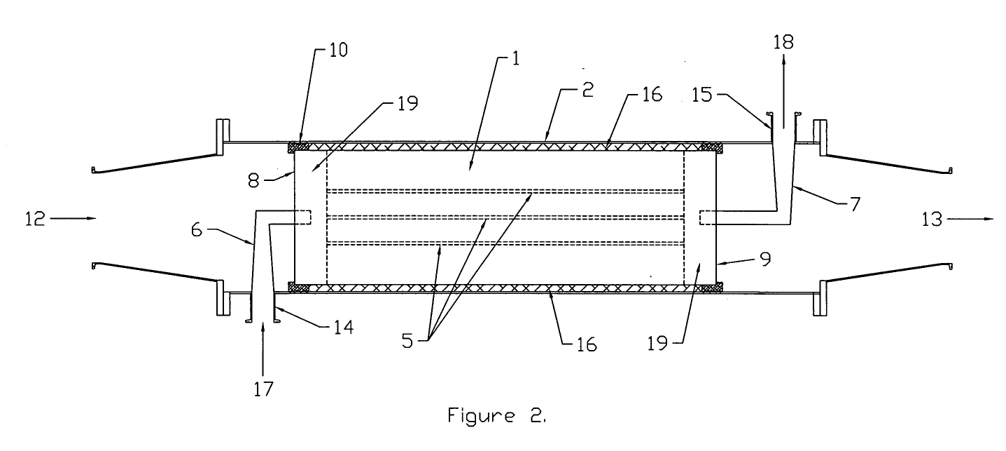

FIG. 2 shows a different means of introduction of a sweep fluid and withdrawal of the sweep fluid and gas-phase permeate. In this embodiment, the sweep fluid is introduced into inlet port 17, through duct 6 into the internal permeate conduit chambers 5, out duct 7, and discharged with the gas-phase permeate through outlet port 18. The communication between the ducts and the permeate chambers 5 is through transverse channels 19, as disclosed in U.S. Pat. No. 5,009,781. Any sweep fluid and gas-phase permeate that might collect in the cavity between the membrane element and the module housing must be isolated from the feed and retentate. This can be accomplished by sealing the exterior surface of the membrane element, for example, with a ceramic glaze or an impermeable plastic wrap to prevent collection in the annulus. Alternatively, this cavity can be isolated at the end faces using seals 10.

While the above drawings and description disclose the introduction of the sweep fluid at or near one end face of the element and the withdrawal of sweep fluid and gas-phase permeate at or near the other end face, it is also possible to have permeate conduit channels along the length of the element, as disclosed in the above-referenced Goldsmith patents. Using appropriate seals, channels along the length of the membrane element can be used for introduction of the sweep fluid into the permeate conduit and/or withdrawal of the sweep fluid and gas-phase permeate from the permeate conduit.

The term gas-phase permeate encompasses both condensable and non-condensable permeates. In pervaporation, the gas-phase permeate would normally be recovered by condensation, and the sweep fluid would be a non-condensable gas. For gas separation processes, the gas-phase permeate is usually non-condensable, in which case a condensable sweep fluid, such as steam, would be employed. In perstraction, the gas-phase permeate would be a soluble material that is dissolved in a liquid sweep fluid.

For the above devices, very compact membrane elements can be constructed. The membrane area per unit volume of the devices can be greater than about 100 square feet per cubic foot of membrane element volume.

The monolith membrane supports can be ceramic, metallic, polymeric, or other suitable porous material. The porosity of the monolith support is generally in the range of about 30 to 50%. The mean pore size of the monolith support is preferably in the range of about 5 microns to about 50 microns, with higher pore sizes affording higher support permeability and necessitating fewer permeate conduits. The membrane elements, including both support and membrane coating applied to the passageway walls of the support, can utilize a single unitary monolith structure or a multi-segment monolith structure. For unitary monoliths or segments in a multi-segment element, the preferred hydraulic diameter of the monolith is greater than about two inches, and the length is greater than about two feet, so as to have a relatively large membrane area per membrane element.

The membrane types for which this invention is applicable can be microporous or dense, and are suitable for the membrane processes of pervaporation, gas separations, and perstraction. The pore sizes of microporous membranes are preferably smaller than about 1 nanometer, and would include materials such as zeolites, microporous silica, carbon molecular sieves, other microporous glass, ceramic, carbonaceous, organic, and metallic materials, or combinations thereof. Dense membrane membranes can be metallic, mixed oxide ion transport membranes, polymeric membranes, filled polymeric membranes, or combinations thereof.

Other embodiments will occur to those skilled in the art and are within the following claims:

1. A membrane device for receiving a feedstock at a feed end face and for separating the feedstock into a gas-phase permeate and retentate, comprising:
a membrane support containing at least one monolith of porous material defining a plurality of passageways, with passageway wall surfaces, extending longitudinally from the feed end face of the monolith to a retentate end face of the monolith through which the feedstock flows to pass retentate from the device;
a permselective membrane coating applied to the passageway wall surfaces;
at least one permeate conduit formed within the monolith, the conduit containing a plurality of longitudinal permeate chambers transected by permeate channels, the channels providing a means for introduction of a sweep fluid into the permeate chambers and withdrawal of the sweep fluid and gas-phase permeate from the permeate chambers; and
a means of separating the sweep fluid and gas-phase permeate flows from the feed and retentate flows.

2. The device of claim 1 in which the membrane support is a single monolith.

3. The device of claim 1 in which the membrane support is a plurality of monolith segments.

4. The device of claim 1 in which the permeate channels are located at or near the end faces of the monolith.

5. The device of claim 4 in which the permeate channels are slots at the end faces of the monolith and are sealed to isolate the permeate chambers from feed and retentate.

6. The device of claim 1 in which the means of sweep fluid introduction and withdrawal are channels which communicate with an annular space between the membrane device and a permeate collection housing.

7. The device of claim 1 in which the means of sweep fluid introduction and withdrawal are ducts at the feed end face and the retentate end face, respectively.

8. A method of separating a feedstock in a membrane device into a gas-phase permeate and retentate, which method comprises:
a) providing a crossflow membrane device of claim 1 contained within a permeate collection housing and means for separating gas-phase permeate from feedstock and retentate flows;
b) introducing a feedstock into the feed end face of the device and into a plurality of the device passageways for separation into a gas-phase permeate and retentate;
c) removing the retentate from the retentate end face of the device; and
d) introducing a sweep fluid into the permeate conduit of the device and removing the sweep fluid and gas-phase permeate from the permeate conduit of the device.
